(19) United States
(12) Patent Application Publication
(10) Pub. No.: US 2003/0111153 A1
(43) Pub. Date: Jun. 19, 2003

(54) Tire-reinforcing bead wires

(75) Inventors: Young-jin Kim, Ulsan-shi (KR); Min-an Kim, Ulsan-shi (KR); Yong-min Park, Ulsan-shi (KR)

Correspondence Address: MERCHANT & GOULD PC, P.O. BOX 2903, MINNEAPOLIS, MN, 55402-0903, US

(73) Assignee: Hyosung Corporation, Seoul (KR)

(21) Appl. No.: 10/238,933

(22) Filed: Sep. 9, 2002

(30) Foreign Application Priority Data
Sep. 17, 2001 (KR) 2001-57107

(51) Int. Cl. B60C 15/04; B60C 9/00; D07B 1/18; B32B 15/02; B32B 15/06

(52) U.S. Cl. 152/540; 152/565; 245/1.5; 428/379; 428/390

(57) ABSTRACT

Disclosed is a tire-reinforcing bead wire coated with benzoic acid, which is advantageous in terms of rubber adhesion. As well, the bead wire shows increased initial and aged adhesion of rubber, high rubber coverage, and suppression of surface oxidation.

### BACKGROUND OF THE INVENTION

1. Field of the Invention

The present invention pertains, in general, to tire-reinforcing bead wires, and in particular, to a tire-reinforcing bead wire coated with benzoic acid to increase rubber adhesion.

2. Description of the Prior Art

Generally, bead wires is steel wires in a diameter of about 0.95 mm made of carbon steel containing 0.6-0.95% of carbon, and plated with 0.3-0.5 μm thick bronze layer. The bead wires are superior in strength, modulus, heat-resistance and fatigue-resistance to other inorganic and organic fibers, thus being applicable to reinforcing bead portions of tires (See FIG. 1).

As for such bead wires, surface oxidation should be avoided through the preparation process of the bead wires in order to obtain excellent adhesion to rubber. However, it is very difficult to regulate the surface oxidation below certain level. Also, the finished bead wires in which surface oxidation is avoided in the process of producing can be easily oxidized in accordance with aging due to heat, stress and moisture.

Therefore, researches for improving initial and aged adhesion and preventing surface oxidation have been carried out by tire cord producers. In particular, surface coating treatment of bead wires using adhesion enhancers has been mainly focused, but formal research results with respect to bead wires are scarcely found. Only some techniques for treatment of steel cord surface by adhesion enhancers have been reported. In this regard, Belgian Pat. No. 786,059 and German Pat. No. 2,227,013 disclose a method of coating the surface of the steel cord with a mineral oil solution of an organic acid and a long chain aliphatic amine salt, or with a mixture of the solution and very small amount of benzotriazole. The key point in such a method is uniform mixing of an oily ingredient and an organic acid contained in the solution. Due to this problem, the above method lacks reproducibility to form uniform solution in preparation, thus the above method is unsuitable for use in practical preparation processes.

In U.S. Pat. No. 4,283,460 by Goodyear Tire & Rubber Company, USA, disclosed are methods for increasing rubber adhesion and surface cleanness of steel tire cord by coating the steel cord with an alcohol solution of a benzotriazole-based compound, a cyclohexylamine borate-based compound or a mixture thereof. This method is advantageous in that the coating solution can be easily produced and thus the method shows good productivity and economic benefit being realized. However, benzotriazole initial and aged adhesion badly, though it improves surface clearness of the steel cord.

Despite much research to improve initial and aged-adhesion between rubber and steel cord or bead wire, only laboratory-level research, regardless of productivity and economic benefit, has been mainly performed. There is thus a need for methods for improvinf rubber adhesion by simpler process.

### SUMMARY OF THE INVENTION

Leading to the present invention, the intensive and thorough research on bead wires, carried out by the present inventors aimed at avoiding the problems encountered in the prior art, resulted in the finding that, when benzoic acid is coated to the surface of a bead wire, adhesion between metal and rubber is increased.

Therefore, it is an object of the present invention to provide a tire-reinforcing bead wire, which is advantageous in light of prevention of surface oxidation on the bead wire and increased adhesion with rubber.

In accordance with an aspect of the present invention, there is provided a tire-reinforcing bead wire, coated with benzoic acid.

In accordance with another aspect of the present invention, there is provided a tire comprising such a bead wire used as a reinforcing material.

### BRIEF DESCRIPTION OF THE DRAWINGS

FIG. 1 shows a tire structure schematically;

FIG. 2a shows an XPS (X-ray photoelectron spectrometer) depth profile of the bead wire according to Example 3;

FIG. 2b shows an XPS depth profile of the bead wire according to comparative Example 3;

FIG. 3a shows only a Sn oxidation profile in the XPS depth profile of FIG. 2a; and

FIG. 3b shows only a Sn oxidation profile in the XPS depth profile of FIG. 2b.

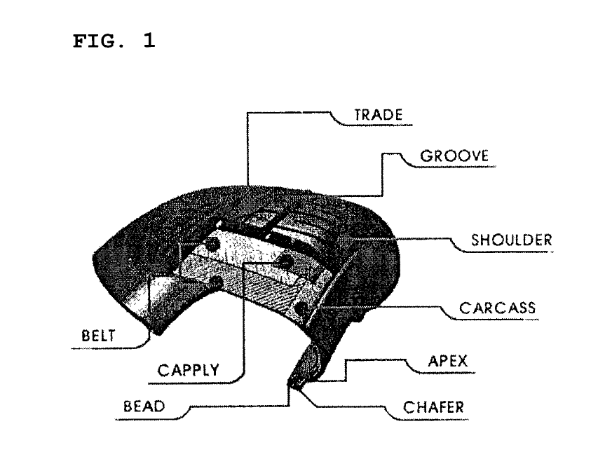

### DETAILED DESCRIPTION OF THE INVENTION

The inventor completed the present invention by finding that rubber adhesion of bead wires is improved when benzoic acid is coated on the bead wires.

Bbenzoic acid is represented by the following formula (1):

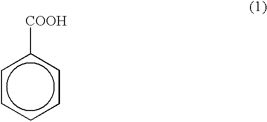

Benzoic acid exists as colorless crystalline fragments at room temperature and has a melting point of 121° C. and a boiling point of 250° C. (sublimated at around 100° C.). Benzoic acid is hardly dissolved in cold water but easily dissolved in hot water, alcohol, ether, etc.

By coating benzoic on the surface of bead wires, segregation problem during rubber mixing is prevented and adhesion of metal to rubber is directly increased at the same time.

The bead wires are coated by passing it through cotton ropes sufficiently soaked with benzoic acid and being dried, right after plating process such as bronze plating.

At this time, an additional coating apparatus is not needed. The cotton ropes through which the bead wires passed are easily soaked with benzoic acid solution by capillary phenomenon. Moreover, the bead wires which are passed through the cotton ropes can be naturally dried before being wound. Thus a separate post-treatment process is unnecessary.

The benzoic acid solution useful in the present invention is prepared by dissolving benzoic acid in a solvent such as alcohol, benzene, toluene, acetone, ether, water, etc in the concentration of 1-20 mol %, preferably 5-10 mol %. In consideration of the solubility of benzoic acid and solvent evaporation after coating, alcohol, particularly methanol, is preferred.

When the concentration of the solution is less than 1 mol %, the resultant bead wires cannot sufficiently improve rubber adhesion. To the contrary, when the concentration exceeds 20 mol %, rubber adhesion and coverage are decreased.

The benzoic acid-coated bead wires according to the present invention are about 5% higher in initial and aged adhesion with rubber than non-coated bead wires. As well, stable rubber coverage is maintained and surface oxidation is prevented.

Having generally described this invention, a further understanding can be obtained by reference to certain specific examples which are provided herein for purposes of illustration only and are not intended to be limiting unless otherwise specified.

### EXAMPLE 1

and

### Comparative Example 1

0.80-0.85% carbon-containing bead wire (A) (Hyosung Corporation, Korea) having a diameter of 0.95 mm plated with bronze comprising 88% Cu and 12% Sn, and 0.80-0.85% carbon-containing bead wire (B) (Hyosung Corporation, Korea) having a diameter of 0.95 mm plated with bronze comprising 97% Cu and 3% Sn were coated with methanol solutions of benzoic acid in the concentrations of 1, 5, 10, 20 and 30 mol % under atmosphere. Control specimen was left uncoated. Thereafter, initial adhesion to available tire rubber having the composition shown in the following Table 1 was determined according to ASTM D1871-84a. Bonded portions between the bead wire and the rubber were observed with the naked eye, while being rotated 360°, to determine rubber coverage. The results are given in Table 2, below.

### EXAMPLE 2

and

### Comparative Example 2

0.80-0.85% carbon-containing bead wire (A) (Hyosung Corporation, Korea) having a diameter of 0.95 mm plated with bronze comprising 88% Cu and 12% Sn, and 0.80-0.85% carbon-containing bead wire (B) (Hyosung Corporation, Korea) having a diameter of 0.95 mm plated with bronze comprising 97% Cu and 3% Sn was coated with methanol solutions of benzoic acid in the concentrations of 1, 5, 10, 20 and 30 mol % under atmosphere. Control specimen was left uncoated. Thereafter, such bead wires were allowed to stand under a circumstance of 30° C./relative humidity 55% for one week. After one week, aged adhesion and rubber coverage was determined according to the same method in Example 1. The results are given in 5 the following Table 2.

TABLE 1
Composition of Tire Rubber

| Component | Part by Weight |
|---|---|
| Nutural Rubber | 100 |
| Peptizer | 0.1 |
| Resorcinol | 3 |
| Process Oil | 10 |
| Stearic Acid | 2 |
| Furance Black | 55 |
| Zinc Oxide | 10 |
| Hexamethylene Terramine | 2 |
| Antioxidant | 0.75 |
| Accelerator | 1 |
| Retarder | 5 |
| Sulfur | 5 |

Note:
Peptizer: Renacit 7 (Bayer)
Process oil: A#2 (Michang Co., Ltd., Korea)
Furance Black: Carbon Black N660 (Lucky Carbon Co., Ltd., Korea)
Antioxidant: 6PPD (Kumbo Monsanto Co., Ltd., Korea)
Accelerator: N-t-butyl-2-benzothiazolesulfenamide (Kumho Monsanto Co., Ltd., Korea)
Retarder: 2,2,4-trimethyl-l,2-dihydroguinone (Kumho Monsanto Co., Ltd., Korea)

TABLE 2

| Bead Wire | | A | | B | | | A | | | | B | | | |
|---|---|---|---|---|---|---|---|---|---|---|---|---|---|---|
| Benz. | | 0% | 30% | 0% | 30% | | 1% | 5% | 10% | 20% | 1% | 5% | 10% | 20% |
| Sol. | | | | | | | | | | | | | | |
| Mol. | | | | | | | | | | | | | | |
| Conc. | | | | | | | | | | | | | | |
| Adhesion | Com. | 79 | 83 | 96 | 117 | Ex. | 83 | 87 | 87 | 85 | 116 | 122 | 119 | 117 |
| (kg/inch²) | Ex.1 | | | | | 1 | | | | | | | | |
| Coverage | | 82 | 83 | 90 | 87 | | 85 | 90 | 88 | 85 | 93 | 95 | 95 | 90 |
| (%) | | | | | | | | | | | | | | |
| Adhesion | Com. | 72 | 79 | 109 | 112 | Ex. | 81 | 82 | 84 | 81 | 115 | 118 | 116 | 113 |
| (kg/inch²) | Ex.2 | | | | | 2 | | | | | | | | |
| Coverage | | 77 | 82 | 90 | 90 | | 83 | 85 | 85 | 83 | 93 | 95 | 93 | 92 |

Note:
A: Sn 12%, Cu 88%,
B: Sn 3%, Cu 97%

From the above Examples and Comparative examples, it can be seen that the bead wires coated with 1-20% benzoic acid solution are superior in both of adhesion and coverage than the non-coated wires. But, in the case of 30% benzoic acid-coated bead wires, excess benzoic acid is attached to the bead wires, and thus the coverage is unfavorably decreased (B type bead wire), even though the adhesion is improved.

### EXAMPLE 3

and

### Comparative Example 3

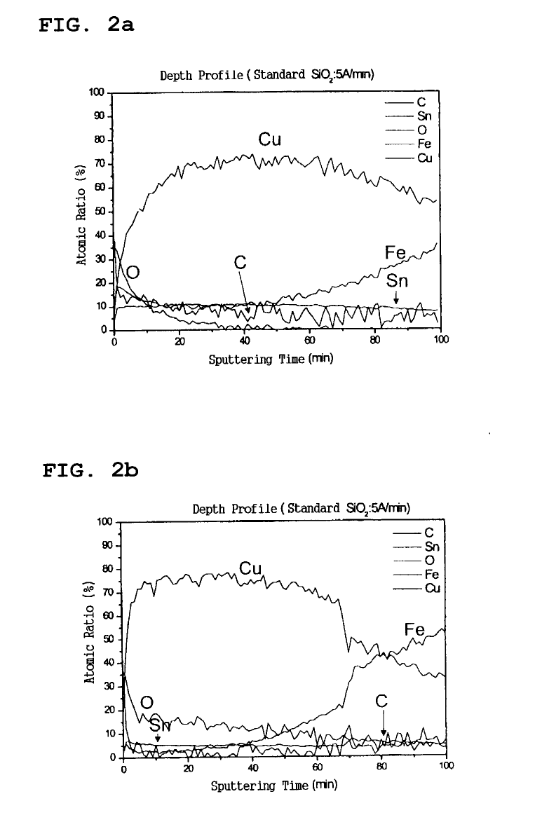

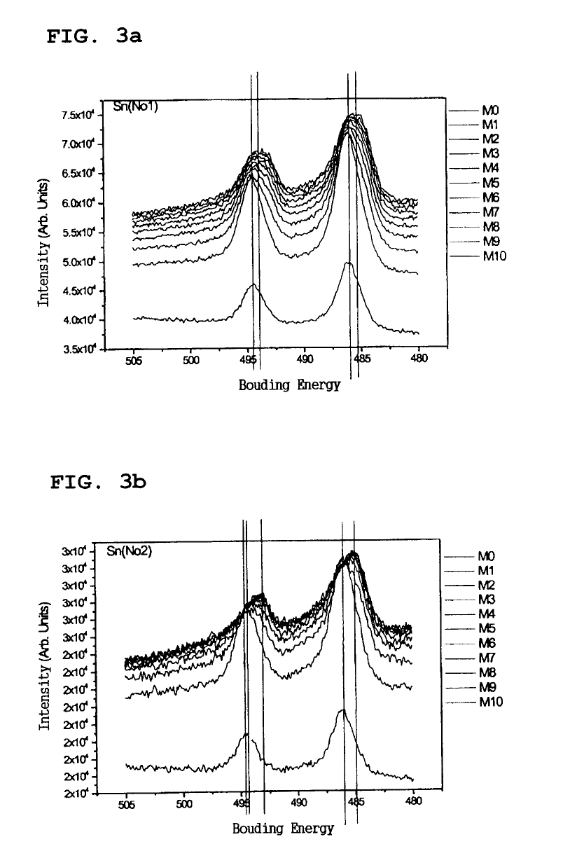

0.80-0.85% carbon-containing bead wire (Hyosung Corporation, Korea) having a diameter of 0.95 mm, plated with bronze comprising 88% Cu and 12% Sn was coated with 5 mol % benzoic acid in methanol solution was coated under atmosphere. Control specimen was left uncoated. Then, such bead wires were allowed to stand under a circumstance of 30° C./relative humidity 55% for one week. After that, surface analysis was performed by X-ray photoelectron spectrometer. XPS depth profiles obtained from such analysis are shown in FIGS. 2a and 2b (FIG. 2a: benzoic acid-coated; FIG. 2b: benzoic acid-noncoated). FIGS. 3a and 3b show only Sn oxidation profiles (Sn: 484.5, 493.3 eV; SnO₂: 486.8, 495.3 eV) (FIG. 3a: benzoic acid-coated; FIG. 3b: benzoic acid-noncoated) in the XPS depth profiles of FIGS. 2a and 2b.

Since Cu and Sn exist as oxides that are thermodynamically stable under atmosphere, an oxide film is naturally formed to the surface of the bead wire. However, as can be seen in FIGS. 2a, 2b, 3a and 3b, the non-coated bead wire is oxidized to its deep internal portion, compared to the bead wires coated with benzoic acid. The results show that a coating treatment using benzoic acid solution can restrain oxidation on the surface of the bead wire, in addition to improving rubber adhesion and coverage.

As described above, according to the present invention, the bead wires, which are advantageous in light of increased initial and aged adhesion of rubber, excellent rubber coverage and restrained surface oxidation, can be easily obtained.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

What is claimed is:

1. A tire-reinforcing bead wire, coated with benzoic acid.

2. The bead wire as set forth in claim 1, wherein the coating is performed by passing a plated bead wire through a cotton rope soaked with 1-20 mol % of benzoic acid solution.

3. The bead wire as set forth in claim 2, wherein the coating is performed by passing a plated bead wire through a cotton rope soaked with 5-10 mol % of benzoic acid solution.

4. A tire containing the bead wire of claim 1 as a reinforcing material.
